(19) United States
(12) Patent Application Publication
(10) Pub. No.: US 2006/0136531 A1
(43) Pub. Date: Jun. 22, 2006

(54) Leading zero counter for binary data alignment

(75) Inventor: Fuk Ho Pius Ng, Plano, TX (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: MathStar, Inc., Minneapolis, MN (US)

(21) Appl. No.: 10/885,205

(22) Filed: Jul. 6, 2004

(51) Int. Cl. G06F 1/16

(52) U.S. Cl. 708/100

(57) ABSTRACT

A method and apparatus are provided for aligning data in a binary word. A coded address is provided for each bit of the binary word. Each coded address is modified as a function of a logic state of the respective bit of the binary word to produce respective modified addresses. A shift control word is generated based on bit positions at which the modified addresses have a predetermined logic state. Bits in the binary word are shifted as a function of the shift control word to produce an aligned binary word.

### FIELD OF THE INVENTION

The present invention relates to semiconductor integrated circuits and, more particularly, to a leading zero counter for use with aligning data within a binary word.

### BACKGROUND OF THE INVENTION

There are many applications in which there is a desire to align or normalize data within a binary word. For example, data normalization is often used in floating point arithmetic. In a binary computer, all numbers are stored in base two. For this reason, normalization of a binary floating point number simply requires that there be no leading zeros after the binary point that separates the 20 place from the 2-1 place. Other normalization and data alignment applications also exist.

A leading zero counter or search is therefore an integral part of a normalization procedure. A leading zero counter provides a shift count, which represents the number of single bit shifts that are required to align the leading-most “1” in the binary word to the left-most significant bit position in the binary word. The same technique can be used to align data in a networking application. For example, if each data segment has a preamble with a leading “1” and trailing zero padding, a leading zero counter can provide information for purging the zero padding and aligning the first bit of the next data segment using a shifter.

Conventional methods of counting or detecting leading zeros use a binary tree detection circuit. The number of logic levels in a binary tree detection circuit is logarithmic to the base two of the number of bits in the binary word. Therefore, the number of bits in the binary word directly translates to the propagation delay through the binary tree detection circuit. The greater the number of bits in the binary word, the greater the propagation delay through the circuit. Another difficulty with binary tree detection circuits is that once a leading zero count value has been determined, that count value must often be further decoded in order to control a shifter. This adds further delay and complexity to the circuit.

Improved leading zero counters and data alignment circuits are therefore desired.

### SUMMARY OF THE INVENTION

One embodiment of the present invention is directed to a method of aligning data in a binary word. The method includes: (a) providing a coded address for each bit of the binary word; (b) modifying each coded address as a function of a logic state of the respective bit of the binary word to produce respective modified addresses; (c) generating a shift control word based on bit positions at which the modified addresses have a predetermined logic state; and (d) shifting bits in the binary word as a function of the shift control word to produce an aligned binary word.

Another embodiment of the present invention is directed to a data alignment circuit. The circuit includes a binary word input and a coded address for each bit of the binary word input. A first logic circuit modifies each coded address as a function of a logic state of the respective bit of the binary word input to produce respective modified addresses. A second logic circuit generates a shift control word based on bit positions at which the modified addresses have a predetermined logic state. A shift circuit shifts bits in the binary word input as a function of the shift control word to produce an aligned binary word output.

Another embodiment of the present invention is directed to a data alignment circuit having a binary word input and a thermometer-coded address for each bit of the binary word input. Each thermometer-coded address is modified as a function of a logic state of the respective bit of the binary word input to produce respective modified addresses. A shift control word is generated based on bit positions at which the modified addresses have a predetermined logic state. Bits in the binary word input are shifted as a function of the shift control word to produce an aligned binary word output.

Another embodiment of the present invention is directed to a method of generating a leading zero count. The method includes: receiving a binary word and generating a count of leading zeros in the binary word with a substantially constant delay regardless of a number of bits in the binary word, except for changes in loading delay caused by changes in the number of bits in the binary word.

### BRIEF DESCRIPTION OF THE DRAWINGS

FIG. 1 is a table, which illustrates the assignment of a thermometer-coded address for each bit of a binary word to be aligned, according to one embodiment of the present invention.

FIG. 2 is a table illustrating modified addresses for the binary word shown in FIG. 1.

FIG. 3 illustrates a multiplexer, which can be used for selecting between an original coded address bit and a predetermined logic state when forming a respective modified address bit.

FIG. 4 is a schematic diagram of a pre-charged wire-NOR circuit that can be used for producing a shift control word bit for one row of the modified addresses shown in FIG. 2.

FIG. 5 is a block diagram illustrating a normalization circuit according to one embodiment of the present invention.

### DETAILED DESCRIPTION OF THE PREFERRED EMBODIMENTS

A leading zero detector is used to count the number of leading zeros in a binary word and provide a shift control word to a shifter for aligning data in the binary word. The shift control word represents the number of single bit shifts that are required to remove any leading zeros in the binary word and to align the leading “1” in the binary word to the left-most significant bit position.

In one embodiment of the present invention, the leading zero counter has a substantially constant propagation delay regardless of the number of input bits and provides a decoded version of the leading zero count. This decoded leading zero count can be directly applied to the shifter without any further decoding or intermediate circuitry. Such a leading zero detector can be used for aligning data in a data networking application or for normalizing data in floating point arithmetic, for example. Other applications also exist.

One embodiment of the leading zero detector will be described with the following example. In this example, the leading zero detector receives an 8-bit binary word, counts the number of leading zeros in the word and outputs an 8-bit shift control word, which represents the number of single-bit shifts required to align or normalize the data. The binary word and the shift control word can have any number of bits in alternative embodiments of the present invention and can have a variety of data formats.

Assume that the binary word to be aligned or normalized has following value:
00010110

In the above binary word, the right-most bit position is the least significant bit position, and the left-most bit position is the most significant bit position. This binary word has three leading zeros. For a data normalization procedure, the remaining bits should be shifted to the left by three bits to produce the following aligned binary word:
10110000

In order to count the number of leading zeros in the original binary word input, each bit of the binary word is assigned with an coded address. One embodiment of the present invention uses a thermometer code format. In this embodiment, the thermometer code format represents the significance of the corresponding bit position. For example, the number of logic “1” symbols in the coded address represents the significance of the bit position, where a coded address having a single “1” represents the least-significant bit position and a coded address having eight “1's” represents the most-significant bit position.

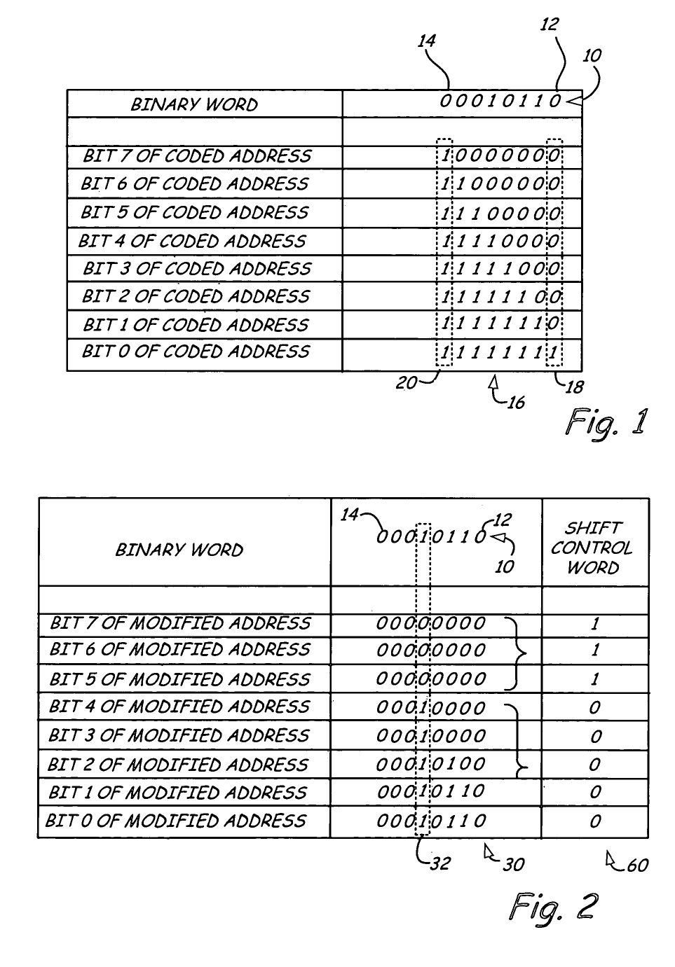

FIG. 1 is a table, which illustrates the assignment of a thermometer-coded address for each bit of the binary word for the example shown above. In FIG. 1, binary word 10 is shown at the top of the table. Binary word 10 has a least significant bit position 12 and a most significant bit position 14. Each bit in binary word 10 is assigned a respective thermometer-coded address 16, which are oriented vertically in FIG. 1. For example, the least significant bit 12 of binary word 10 is assigned a thermometer-coded address 18. The most significant bit 14 in binary word 10 is assigned a thermometer-coded address 20. Each thermometer-coded address has a plurality of bits, labeled “BIT 0” to “BIT 7” in FIG. 1. BIT 0 is the least significant bit of the coded addresses, and BIT 7 is the most significant bit of the coded addresses. Thus, all bits of the thermometer-coded addresses 16 that are in the same row in FIG. 1 have the same significance.

Each thermometer-coded address 16 is then modified as a function of a logic state of the respective bit of the binary word 10 to produce respective modified addresses. For example if the corresponding bit in binary word 10 is “1”, the respective thermometer-coded address 16 is preserved unchanged in the modified address. Otherwise if the corresponding bit is “0”, the respective modified address is reset to all zeros.

FIG. 2 is a table illustrating modified addresses 30 for the binary word 10 shown in FIG. 1. In this example, the modified addresses corresponding to bit positions 0, 3 and 4-6 (numbered from least significant to most significant) in binary word 10 are reset to all zeros, and the modified addresses corresponding to bit positions 1, 2 and 4 in binary word 10 are preserved. The modified address having the greatest number of “1's” corresponds to the bit position in binary word 10 that contains the leading-most “1”, as shown by block 32.

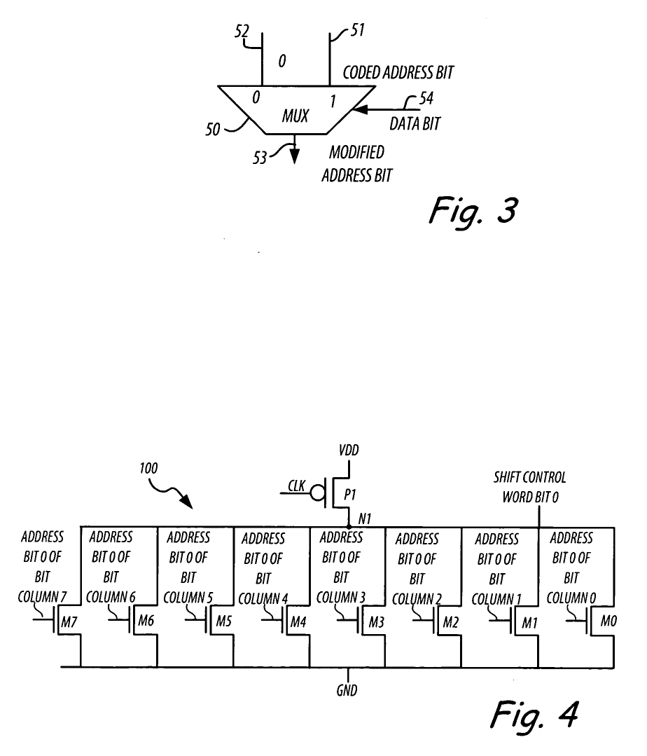

The modification of the coded addresses can be accomplished by a variety of logic circuits or by software. For example, FIG. 3 illustrates a multiplexer 50, which can be used for selecting between an original coded address bit and a predetermined logic state (such as a zero) when forming a respective modified address bit. One mulitiplexer 50 is used for each bit of each coded address. Multiplexer 50 includes a first input 51 coupled to the corresponding coded address bit, a second input 52 coupled to a logic zero state and an output 53 forming the corresponding modified address bit. Multiplexer 50 has a select input 54 which is coupled to the corresponding data bit for selecting between the original coded address bit on input 51 or the logic zero state on input 52 as a function of the logic state of the data bit.

Once the modified addresses 30 are generated, a shift control word 60 is generated based on the bit positions at which the modified addresses have a predetermined logic state (such as a logic “1” state). Shift control word 60 has one bit for each bit position of modified addresses 30. Each bit of the shift control word is generated by detecting whether there is a logic “1” state in any of the corresponding bit positions that have the same significance in modified addresses 30. Looking at FIG. 2, this detection can be made by checking whether there is a logic “1” state in each row of modified addresses 30. If there is a “1” among the modified address bits for that row, the corresponding shift control word bit is a zero. Otherwise, the shift control word bit is a one. This logic operation corresponds to a logic NOR operation. For the example shown in FIG. 2, the resulting shift control word is “11100000” since modified address 32 has logic “1” states in rows 0-4.

If the shift control word “11100000” is inverted, it becomes “000111111”, which corresponds to column address five. This reflects that the most significant “1” in binary word 10 appears at the fifth bit (bit position four when counting from zero). Also, if the order of the bits in shift control word 60 are reversed from “11100000” to “00000111”, this produces a thermometer-coded value that represents the number (three) of single-bit left shifts required to normalize this particular binary word 10. Thus, a shift circuit can receive shift control word 60 directly and use the shift control word for controlling the operation of internal shift multiplexers without any intermediate decoding. This further reduces the overall delay of the data alignment for a normalization process.

FIG. 4 is a schematic diagram of a pre-charged wire-NOR circuit 100 that can be used for producing one bit of the shift control word 60 for one row of the modified addresses 30. In this example, circuit 100 is configured for detecting the logic states of the first row, corresponding to BIT 0 of each modified address 30. Circuit 100 includes a P-channel precharge transistor P1 and one N-channel pull-down transistor M0-M7 for each modified address 30. Transistor P1 is coupled between voltage supply terminal VDD and common node N1. The control terminal of transistor P1 is coupled to a suitable clock signal CLK. Transistors M0-M7 are coupled in parallel with one another between common node N1 and power supply terminal GND. Each transistor M0-M7 has a control terminal coupled to BIT 0 of the corresponding modified address. Common node N1 generates the output of circuit 100, which corresponds to BIT 0 of shift control word 60. There is one wire-NOR circuit 100 for each bit of shift control word 60.

If any of the address bits for the respective row is a logic “1”, then the corresponding transistor will pull common node N1 low toward ground terminal GND, thereby producing a logic “0” for the corresponding shift control word bit. If none of the address bits for that row is a logic “1”, then common node N1 remains in the logic high state such that BIT 0 of the bit control word is a logic “1”.

In the example shown in FIG. 4, if the number of bits in the input binary word is increased or decreased, the delay through circuit 100 remains substantially constant except for a change in loading delay caused by a corresponding increase or decrease in the number of pull-down transistors in the circuit.

The wire-NOR circuit 100 shown in FIG. 4 is one example of a logic circuit that can be used for detecting the presence of a predetermined logic state in the respective bits having equal significance in the modified addresses. Many other logic circuits can also be used.

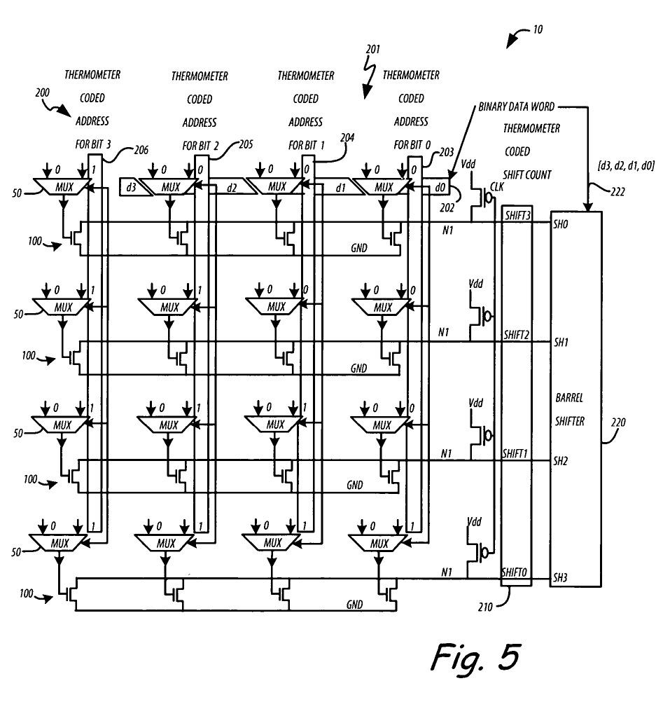

FIG. 5 is an overall block diagram illustrating a normalization circuit 200 comprising a leading zero counter 201 and a shifter 220 according to one embodiment of the present invention. For simplicity, FIG. 5 illustrates an example in which binary word input 10 has four bits instead of eight bits. However, circuit 200 can be modified to process binary words having any number of bits in alternative embodiments of the present invention. The same reference numerals are used in FIG. 5 as were used in FIGS. 1-4 for the same of similar elements.

In this example, the binary word 10 has four bits labeled d3, d2, d1 and d0, with bit d3 being the most significant and bit d0 being the least significant. Bits d3-d0 are provided as inputs to leading zero counter 201 and shifter 220. Leading zero counter 201 includes and array of multiplexers 50 and a plurality of logic NOR circuits 100.

Block 202 represents the bits of binary word 10 being applied to the select inputs of respective multiplexers 50. Block 203 represents a predetermined thermometer-coded address “0001” that is assigned to bit zero of binary word 10. Each bit of address 203 is coupled to one of the data inputs of a respective multiplexer 50. Similarly, block 204 represents a predetermined thermometer-coded address “0011” that is assigned to bit one of binary word 10. Block 205 represents a predetermined thermometer-coded address “0111” that is assigned to bit two of binary word 10. Block 206 represents a predetermined thermometer-coded address “1111” that is assigned to bit three of binary word 10. Again, each bit of addresses 204-206 is coupled to one of the data inputs of a respective multiplexer 50. As described above with respect to FIG. 3, the other data input of each multiplexer 50 is coupled to a logic “0” state. The thermometer-coded address for a particular bit position in binary word 10 is fixed for a particular embodiment of the present invention.

Each column of multiplexers 50 in FIG. 5 generates one of the modified addresses 30 described with reference to FIG. 2 (for a 4-bit example). Each row of multiplexers 50 in FIG. 5 generates one of the rows of modified address bits shown in FIG. 2 (for a 4-bit example) and provides the row of bits to a respective logic NOR circuit 100.

The output of each logic NOR circuit 100 at the respective node N1 generates a corresponding bit of shift control word 60. Leading zero counter 201 therefore generates a thermometer-coded shift control word, which is simply a decoded binary number. Block 210 represents the shift control word that is generated by leading zero counter 201. Shift control word 210 has four bits labeled SHIFT0 to SHIFT3, with SHIFT0 being the least significant and SHIFT3 being the most significant. Shift circuit 220 can use the shift control word directly to control the number of bits for the shift operation without any further decoding.

Shift circuit 220 can include any type of shifter, such as a barrel shifter. Shift circuit 220 includes a data input 222 and a plurality of shift control inputs SH0 to SH3. Data input 222 is coupled to binary word 10. Shift control inputs SH0 to SH3 are coupled directly to respective bits of the shift control word in an order of reverse significance. Although the bits of the shift control word are reversed, it is only a matter of connection to the appropriate shift control inputs of shift circuit 220. No additional decoding circuit is required. In one embodiment, shift circuit 220 includes internal shift multiplexers having select inputs that are directly controlled by the bits of the shift control word.

The normalization circuit shown in FIG. 5 reduces the overall delay of a binary normalization process. Leading zero counter 201 has two logic levels. Contrary to binary logic trees of the prior art, the number of logic levels in leading zero counter 201 is independent of the number or bits in the binary word input. Therefore, the propagation delay through leading zero counter 201 is substantially constant except for changes in loading delays within wire-NOR circuits 100.

Although the present invention has been described with reference to preferred embodiments, workers skilled in the art will recognize that changes may be made in form and detail without departing from the spirit and scope of the invention. For example, the various function blocks of the present invention can be implemented in hardware, software or a combination of both hardware and software. Also, a variety of circuit configurations can be used in replace of the circuit configurations shown in the figures. The term “coupled” can include a direct connection or a connection through one or more intermediate components. Further, it is to be understood that particular logic states are interchangeable, and any circuitry can be inverted or otherwise modified to implement a particular convention or technology.

What is claimed is:

1. A method of aligning data in a binary word, the method comprising:
(a) providing a coded address for each bit of the binary word;
(b) modifying each coded address as a function of a logic state of the respective bit of the binary word to produce respective modified addresses;
(c) generating a shift control word based on bit positions at which the modified addresses have a predetermined logic state; and
(d) shifting bits in the binary word as a function of the shift control word to produce an aligned binary word.

2. The method of claim 1 wherein step (a) comprises providing a thermometer-coded address for each bit of the binary word, wherein each thermometer-coded address represents a relative bit position of the respective bit in the binary word.

3. The method of claim 1 wherein step (b) comprises, for each coded address, setting all bits of that coded address to a first predetermined logic state if the logic state of the respective bit of the binary word is a second predetermined logic state to thereby produce the respective modified addresses.

4. The method of claim 1 wherein step (b) comprises, for each coded address, setting all bits of that coded address to a logic zero state if the logic state of the respective bit of the binary word has a logic zero state and leaving the coded address unchanged if the logic state of the respective bit of the binary word has a logic one state.

5. The method of claim 1 wherein step (c) comprises generating the shift control word based on a greatest significant bit position within the modified addresses at which at least one of the modified addresses has the predetermined logic state.

6. The method of claim 1 wherein step (c) comprises generating the shift control word based on a highest significant bit position within all the modified addresses at which at least one of the modified addresses has the predetermined logic state.

7. The method of claim 6 wherein step (c) comprises generating each bit of the shift control word by performing a logical OR of respective bits having equal significance in the modified addresses.

8. The method of claim 7 wherein step (c) comprises performing a wire-NOR function on the respective bits having equal significance in the modified addresses to produce each bit of the shift control word.

9. The method of claim 1 wherein step (c) comprises generating the shift control word such that the number of bits in the shift control word having a predetermined logic state represents a number of bit positions by which the binary word is shifted to produce the aligned binary word.

10. The method of claim 1 wherein step (d) comprises normalizing the binary word such that a most significant bit of the aligned binary word has a predetermined logic state.

11. The method of claim 1 wherein step (d) comprises shifting the bits in the binary word with a barrel shifter.

12. The method of claim 11 wherein step (d) comprises coupling bits of the shift control word to respective bits of a shift control input of the barrel shifter in an order of reverse significance.

13. A data alignment circuit comprising:
a binary word input;
a coded address for each bit of the binary word input;
a first logic circuit, which modifies each coded address as a function of a logic state of the respective bit of the binary word input to produce respective modified addresses;
a second logic circuit, which generates a shift control word based on bit positions at which the modified addresses have a predetermined logic state; and
a shift circuit, which shifts bits in the binary word input as a function of the shift control word to produce an aligned binary word output.

14. The data alignment circuit of claim 13 wherein the coded addresses comprise a thermometer-coded address for each bit of the binary word input, and wherein each thermometer-coded address represents a relative bit position of the respective bit in the binary word input.

15. The data alignment circuit of claim 13 wherein, for each coded address, the first logic circuit sets all bits of that coded address to a first predetermined logic state if the logic state of the respective bit of the binary word input is a second predetermined logic state to thereby produce the respective modified addresses.

16. The data alignment circuit of claim 15 wherein the first logic circuit comprises a multiplexer for each coded address, which selects between a logic zero address and the coded address to produce the respective modified address as a function of the logic state of the respective bit of the binary word input.

17. The data alignment circuit of claim 13 wherein the second logic circuit generates each bit of the shift control word based on whether any of the corresponding bits having the same significance in the modified addresses has a logic one state.

18. The data alignment circuit of claim 13 wherein the second logic circuit comprises, for each bit of the shift control word, a logic OR circuit which generates that bit of the shift control word by performing a logic NOR of respective bits having equal significance in the modified addresses.

19. The data alignment circuit of claim 18 wherein the logic OR circuit comprises a plurality of inputs coupled to the respective bits of the modified addresses, wherein each bit has the same significance, and an output coupled to the respective bit of the shift control word.

20. The data alignment circuit of claim 13 wherein the number of bits in the shift control word having a predetermined logic state represents a number of bit positions by which the binary word input is to be shifted by the shift circuit to produce the aligned binary word output.

21. The data alignment circuit of claim 13 wherein the aligned binary word output comprises a normalization of the binary word input such that a most significant bit of the aligned binary word output has a predetermined logic state.

22. The data alignment circuit of claim 13 wherein the shift circuit comprises a barrel shifter.

23. The data alignment circuit of claim 13 wherein the shift circuit comprises a plurality of shift control inputs having an order of significance, and wherein the bits of the shift control word are directly coupled to the plurality of shift control inputs in an order of reverse significance without any intermediate decoding.

24. A data alignment circuit comprising:
a binary word input;
a thermometer-coded address for each bit of the binary word input;
means for modifying each thermometer-coded address as a function of a logic state of the respective bit of the binary word input to produce respective modified addresses;
means for generating a shift control word based on bit positions at which the modified addresses have a predetermined logic state; and
means for shifting bits in the binary word input as a function of the shift control word to produce an aligned binary word output.

25. A method of generating a leading zero count, the method comprising:
receiving a binary word; and
generating a count of leading zeros in the binary word with a substantially constant delay regardless of a number of bits in the binary word, except for changes in loading delay caused by changes in the number of bits in the binary word.

26. The method of claim 24, wherein the count comprises a binary word having a number of logic ones corresponding to the count.
